(19) United States
(12) Patent Application Publication
(10) Pub. No.: US 2005/0166052 A1
(43) Pub. Date: Jul. 28, 2005

(54) Methods and apparatus to authenticate a document

(76) Inventors: Ron Khormaei, San Diego, CA (US); Loren Chapple, Vancouver, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/764,645

(22) Filed: Jan. 24, 2004

(51) Int. Cl. H04L 9/00

(52) U.S. Cl. 713/176; 380/277

(57) ABSTRACT

In one representative embodiment the present invention provides for a method of generating an authentication key that can be used to authenticate an electronic document file representative of a document. The method includes providing the electronic document file as an initial digital file, and applying a predetermined halftoning process to the digital file to generate a digital halftone file of a plurality of discrete digital values. A predetermined mathematical process is then performed on the plurality of discrete digital values to thereby generate the authentication key.

### BACKGROUND

Electronic documents are routinely sent from one person to another via the Internet or over other networks. During transmission it is possible that an electronic document can be intercepted and altered, or become corrupted in transmission. In many instances an altered document can have significant consequences. For example, if a contract in the way of an electronic document were intercepted and altered to remove the word “not”, or to change a dollar value, it could have significant financial implications. It is therefore desirable to be able to verify the authenticity of an electronic document that is transmitted from a sender to a receiver by way of a network or other means.

### SUMMARY

A first embodiment the present invention provides for a method of generating an authentication key that can be used to authenticate an electronic document file representative of a document. The method includes providing the electronic document file as an initial digital file, and applying a predetermined halftoning process to the digital file to generate a digital halftone file of a plurality of discrete digital values. A predetermined mathematical process is then performed on the plurality of discrete digital values to thereby generate the authentication key.

Another embodiment of the present invention provides for a system to generate an authentication key to be used to authenticate an electronic document file representative of a document. The system includes a processor and a computer readable memory device which is readable by the processor. The computer readable memory device contains a series of computer executable steps configured to cause the processor to perform the following steps: retrieve a copy of the electronic document file as an initial digital file; apply a predetermined halftoning process to the initial digital file to generate a digital halftone file comprising a plurality of discrete digital values; perform a predetermined mathematical process on the plurality of discrete digital values to thereby generate the authentication key; and store a copy of the authentication key in the computer readable memory device.

These and other aspects and embodiments of the present invention will now be described in detail with reference to the accompanying drawings, wherein:

### DESCRIPTION OF THE DRAWINGS

FIG. 1 is a flowchart depicting a method in accordance with a first embodiment of the present invention.

FIG. 2 is a flowchart depicting a method in accordance with a second embodiment of the present invention.

FIG. 3 is a schematic diagram depicting a system in accordance with another embodiment of the present invention.

FIG. 4 is a schematic diagram depicting a system in accordance with a further embodiment of the present invention.

### DETAILED DESCRIPTION

Non-limiting embodiments of the present invention provide for methods and apparatus for generating an authentication key for an electronic document file at a source of the electronic document file (such as a sender or creator of the electronic document file), and verifying the authenticity of an electronic document file by generating an authentication key for the electronic document file at a receiver location of the electronic document file. The receiver of the electronic document file can then compare the authentication key generated by the receiver at the receiver location to the authentication key generated at the source. If the two authentication keys match, then the authenticity of the electronic document file as received by the receiver is verified. As will be described more fully below, the authentication key can be generated using a halftoning process (i.e., using a halftoning algorithm).

Halftoning is a process that is used to convey gray scale information in printers which typically can print only black or white. Halftoning techniques are also used in color printers (discussed more fully below). Many halftone concepts and terms now used in electronic printing originated with the classic offset printing press. Printing presses can usually print areas of single intensity as they have only an ability to apply ink to a page or not apply ink to the page. This limited ability results in only two colors, i.e., that of the ink and that of the print media. By varying the size of printed dots, however, it is possible to give the impression of various shades of gray.

In electronic black and white printers, gray scales are accomplished by building a palette of grays that consists of clusters of black dots. A given cluster with more black dots is darker, while a cluster with less black dots is perceived as a lighter gray.

Halftone principles and procedures are applicable to color printers as well. In a color printer, the halftone technique is applied to each color plane (usually Cyan, Magenta, Yellow and blacK (CMYK)). Instead of generating only shades of gray, the printer provides mixtures of varying intensities of the four color planes. Layering of those variable intensity color planes enables the printing of a generally “full color” document.

In addition to halftoning for printing purposes, halftoning techniques can also be used in the display of an image, such as on a computer monitor.

Digital halftoning can thus be defined as a collection of techniques employed by various computer-controlled display and printing devices for converting continuous-tone images into binary information for displaying the image. The display or printed image is comprised of many individual picture elements, known as “pixels.” The computer generates data corresponding to the tone of the pixels to be displayed or printed. Hereafter, this data will be alternatively referred to as input tone values or tone value data.

The conversion and display of the tone value data is often referred to as rendering. As part of the rendering, the tone value data is associated with halftoning cells with which the display area is logically tiled. The pixels of those cells are colored (printed or displayed) in accord with the underlying halftoning technique. The halftoning techniques, or algorithms, can be generally broken-down into two classes.

One class of halftoning techniques comprises those algorithms that are relatively simple from a computational standpoint, thus providing good rendering speed. Exemplary of this first class of halftoning algorithms are those known as matrix-based, pattern, or ordered-dither algorithms.

Another class of halftoning algorithms includes those generally labeled as “error diffusion” halftoning algorithms. A popular version of an error diffusion halftoning algorithm is known as Floyd-Steinberg error diffusion. With this technique, the tone value of each pixel is examined (for colored output, the tone values include those of each colorant) and compared to a threshold value provided by the algorithm. If the incoming tone value exceeds the threshold, an output pixel is generated and the difference between the output and input values (error) is diffused among four neighboring pixels. For example, the pixel immediately to the right of the current pixel is assigned 7/16 of the error (the error can be positive or negative), the pixel beneath that one is assigned 1/16 of the error, the pixel beneath the current pixel is assigned 5/16 of the error, and the pixel to the left of that one is assigned 3/16 of the error. To further break-up geometric artifacts or patterns, some noise may be added to the error terms. The averaged value of the noise is 0, however, so that the image is not lightened or darkened as a result.

Examples of halftoning algorithms are provided in U.S. Pat. No. 5,313,287 (“Imposed weight matrix error diffusion halftoning of image data”), U.S. Pat. No. 5,949,964 (“Method and apparatus for halftoning of images in a printer”), and U.S. Pat. No. 6,002,804 (“Tone dependent variable halftoning with adjustable algorithm selection”), all of which are assigned to the assignee of the present application.

Following halftoning of an initial digital file, such as an electronic document file, a digital halftone file is produced. The digital halftone file can then be used by a processor resident within an imaging device, typically with additional processing, to enable the imaging device to print a tangible copy of a document represented by the electronic document file. The digital halftone file is a bitmap file comprised of a plurality of discrete digital values, and as such is capable of being numerically processed to generate an authentication key according to the methods described further herein, in accordance with the present invention.

Typically, in a printing process, the halftoning algorithms are resident within a computer readable memory device (such as a random access memory, or RAM) resident within an imaging device. The term “imaging device” or “printing device”, as used herein, is intended to include, for example, stand-alone printers (such as ink jet printers, laser printers, etc.), photocopiers, and combination devices (known as “multi-function peripherals”). As indicated above, halftoning algorithms are frequently proprietary to the manufacturer of the imaging device. Further, since halftoning algorithms are typically embedded within a ROM device they are difficult for a user to access and thus reverse engineer. For this reason using the halftoning algorithm to generate an authentication key provides a fairly high degree of security since the halftoning algorithm used to generate the authentication key is not easily accessed.

As indicated above, embodiments of the present invention allow a first user (a “sender”) to generate an authentication key for an electronic document file by halftoning the electronic document file, and then using the resulting digital halftone file to generate the authentication key. The user can then transmit the electronic document file to a second user (a “receiver”) over a network. The sender can also transit the authentication key to the receiver (typically separately from transmission of the electronic document file). The receiver can then use the electronic document file to generate an authentication key (“receiver authentication key”) in the same manner as described above with respect to the sender. The receiver can then compare the authentication key received from the sender with the receiver authentication key. If the two keys match, it is highly probable that the electronic document file was not altered or corrupted between the time the sender generated the sender's authentication key and the time the receiver generated the receiver authentication key.

Since halftoning algorithms are frequently proprietary to the manufacturer of an associated imaging device, the digital halftone file generated by one make and model of an imaging device will typically be different than the digital halftone file generated by a different make and model of an imaging device. Since the authentication key is generated using the digital halftone file, authentication keys generated using different halftoning algorithms typically will not match. Accordingly, two users of methods and apparatus described further below will generally need to have access to the same halftoning algorithm, either by way of having essentially similar or identical imaging devices, of by having the halftoning algorithms accessible by other means (such as resident within a user computer).

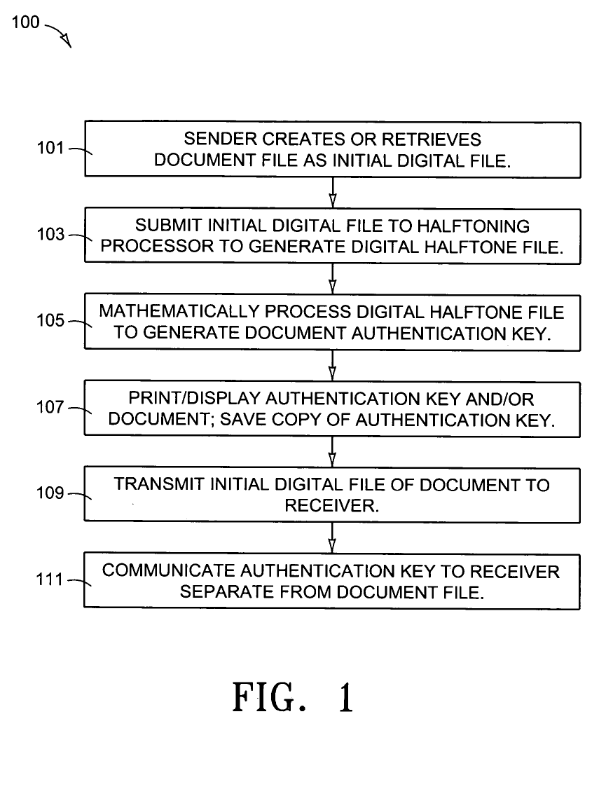

Turning now to FIG. 1, a flowchart 100 depicts a method in accordance with a first embodiment of the present invention. As will be described more fully below, the method depicted by the flowchart 100 can generally be described as a method of generating an authentication key that can be used to authenticate an electronic document file representative of a document. The flowchart 100 will be described with respect to a “sender” performing the method. The method includes providing the electronic document file as an initial digital file. Thus, at step 101 the sender creates or retrieves (from computer readable memory) the electronic document file. For example, using a “sender computer” (such as a personal computer) the sender can select the electronic document file for which an authentication key is to be generated.

The method next includes applying a predetermined halftoning process to the digital file to generate a digital halftone file comprising a plurality of discrete digital values. Thus, at step 103 the sender submits the initial digital file to a halftoning processor to generate the digital halftone file. For example, the user can transmit the electronic document file to an imaging device, such as an ink jet printer, and a processor resident within the printer can generate the digital halftone file as part of the normal printing process. As indicated above, exemplary halftoning processes include, without by way of limitation, error diffusion halftoning algorithms, matrix-based halftoning algorithms, pattern-based halftoning algorithms, and ordered-dither halftoning algorithms.

Once the digital halftone file is generated, then a predetermined mathematical process is performed on the plurality of discrete digital values (in the digital halftone file) to thereby generate the authentication key, as indicated at step 105 of the flowchart 100. As will be described in fuller detail below, the predetermined mathematical process can be part of an authentication key generation routine stored in a ROM device within the imaging device, and can take the form of a number of different mathematical algorithms (so long as the sender and the intended receiver of the electronic document file use the same algorithm). One example of a mathematical process that can be performed on the digital halftone file is a simple summation of the digital values representative of all of the halftoned pixels which make up the image. For example, in a four color printing process, each pixel will be represented by four 8-bit values. All of the 8-bit values can be added together, and the resulting sum is the authentication key. As this can be a rather large number, even when presented to a user in hexadecimal form, the mathematical process can further include truncating all but a predetermined number of final digits, for example, the last six digits. Another exemplary mathematical process that can be performed on the digital halftone file is a simple summation of the last binary number of the digital values representative of the halftoned pixels. This results in a much smaller final number, but can decrease the probability that any two different electronic document files (e.g., an original document file and an altered document file) will render different authentication keys.

With respect to FIG. 1, at step 107 the method can include printing the digital halftone file to provide a tangible copy of the document containing a visible representation of the authentication key. Alternately, only the authentication key can be printed since the sender may not desire to have a printed copy of the document at that time, but may wish to have a copy of the authentication key. Further, rather than printing the document and/or the authentication key, one or both of the document and the authentication key can be displayed on a user display, such as a computer monitor, to provide a visible (non-tangible) copy of the document and/or the authentication key. In any event, after the authentication key has been generated, the sender typically will save a copy of the authentication key for later authentication and verification purposes.

At step 109 of the flowchart 100 the sender can transmit the electronic document file (in the form of the initial digital file) to the receiver (i.e., intended recipient) of the document. For example, the sender can send the electronic document file to the receiver as an attachment to an e-mail, or by placing the document file on a commonly accessible server. The electronic document can be sent to the receiver over a global network (e.g., the Internet), via a local or wide area network, or by other means for transmitting electronic document files from a first location (sender location) to a second location (receiver location).

It will also be appreciated that the method depicted in the flowchart does not require the transmission step 109. For example, as indicated earlier, following saving the authentication key at step 107, the “sender” can store the electronic document on a server or the like where access by third parties is possible. Thereafter, the “sender” can use the authentication key (as described further below) to verify that the document has not been altered.

At step 111 of the flowchart 100 the authentication key can be separately communicated to the receiver (i.e., separate from the electronic document file as transmitted to the receiver at step 109). For example, the sender can send the electronic document file and the authentication key to the receiver as attachments to separate e-mails. Alternately, for example, the sender can send the authentication key to the receiver by facsimile, or by voice message (as for example, via a telephone), by cellular phone text message, etc. Further, the electronic document file and the authentication key can be transmitted to the receiver together. Since, as described above, the authentication key is dependent on the halftoning algorithm used to generate the halftone digital file, and since a third party who may intercept the electronic document file will typically not know which halftoning algorithm was used to generate the authentication key, it is unlikely that a third party will be able to alter the electronic document file without affecting the authentication key generated by the receiver.

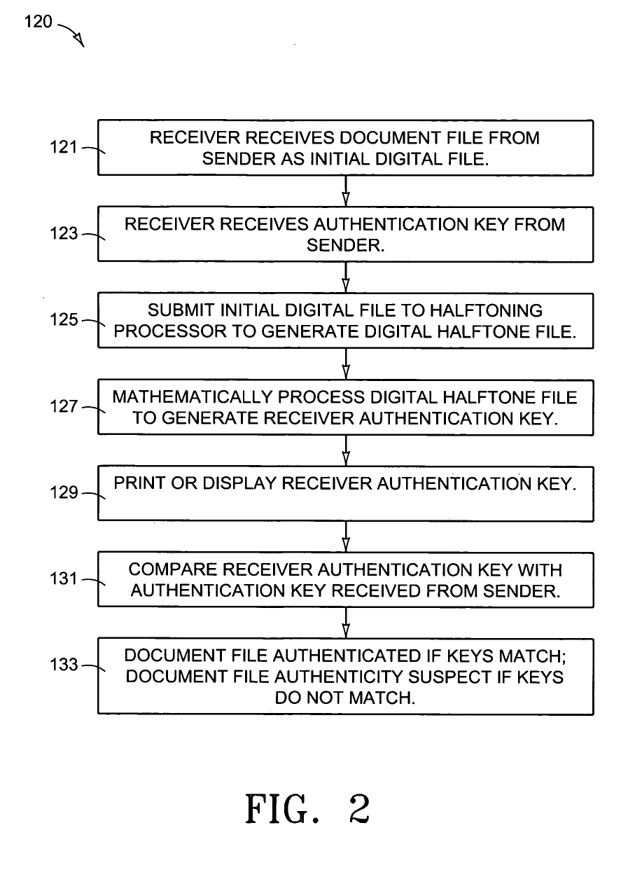

Turning now to FIG. 2, a flowchart 120 depicts a method in accordance with a second embodiment of the present invention. As will be described more fully below, the method depicted by the flowchart 200 can generally be described as a method of authenticating an electronic document file representative of a document. That is, whereas the flowchart 100 of FIG. 1 represents a method that can be used by a “sender” to generate an authentication key for an electronic document file, the flowchart 120 of FIG. 2 represents a method that can be used by a receiver to subsequently authenticate the electronic document file using the authentication key. Consequently, at step 121 the receiver receives the electronic document file as an initial digital file. As indicated above with respect to the discussion of FIG. 1, and especially step 109 thereof, the “sender” and “receiver” can be different entities, or the same entity. As also indicated above, the receiver can receive the document in any number of ways as indicated above, including via a network, on tangible memory media (such as a CD ROM), etc.

At step 123 of FIG. 2, and as described above with respect to step 111 of FIG. 1, the receiver also receives the authentication key that was generated by the sender (that is, the key generated following the method generally described above with respect to FIG. 1). As indicated above, the receiver can receive the authentication key from the sender in any number of ways as indicated above, including via an e-mail, a telephonic message, facsimile, etc. The sender-then generates a “sender” authentication key using the electronic document file received from the receiver. That is, at step 125 the receiver submits the electronic document file to a halftoning processor to generate a digital halftone file (in substantially the same manner as described above with respect to step 103 of FIG. 1), and at step 127 (FIG. 2) the halftoned digital file is mathematically processed (in substantially the same manner as described above with respect to step 105 of FIG. 1) to generate an authentication key (the “receiver authentication key”). As described above, the halftoning process (halftoning algorithm) used by the sender in generating the initial authentication key, and the halftoning process used by the receiver in generating the “receiver authentication key”, generally need to be the same halftoning process. Likewise, the mathematical process used by both the sender and receiver to generate the key from the digital halftoned files needs to be the same.

After the receiver has generated the authentication key at step 127 (FIG. 2), then at step 129 the receiver can print or otherwise display (via a computer monitor, for example) the user-generated authentication key. At this point, the receiver has both authentication keys (the one received from the sender and the one generated by the receiver), and at step 131 the receiver can then use the authentication keys to authenticate the electronic document file. That is, at step 133 the user can compare the two keys to one another and, if the two keys match, then the receiver has verified the authenticity of the electronic document file received at step 121. However, if at step 133 the keys do not match, then the authenticity of the electronic document file received at step 121 is suspect, and the receiver can take whatever steps are deemed appropriate.

It will be appreciated that the flowcharts 100, 120 of respective FIGS. 1 and 2 together represent but one example of a method for generating a document authentication key for an electronic document file, and using the authentication key to authenticate the electronic document file, in accordance with the present invention. It will be further appreciated that the flowcharts 100, 200 are exemplary only, and that additional and/or different steps can be used, and the steps performed in a different order, all in accordance with embodiments of the present invention.

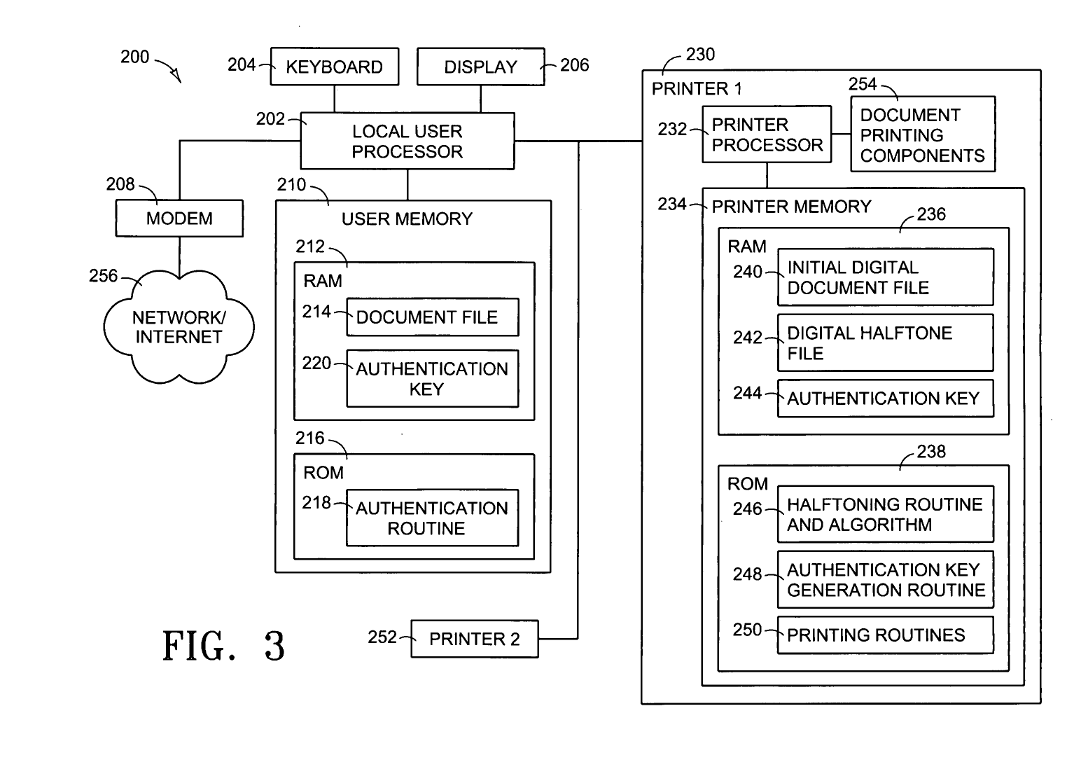

Turning now to FIG. 3, a system 200 in accordance with a third embodiment of the present invention is depicted in a schematic diagram. As will be described in more detail below, the system 200 can generate an authentication key which for use in authenticating an electronic document file representative of a document, and can also be used to authenticate an electronic document file representative of a document. The system 200 can be used, for example, to perform either or both of the methods indicated by flowcharts 100, 120 of respective FIGS. 1 and 2, and variations thereof. It will be appreciated from the following description that the system 200 depicted in FIG. 3 is exemplary only, and that additional, fewer and/or different components can be used to equal effect.

The system 200 includes a processor and a computer readable memory device which is readable by the processor. As depicted in FIG. 3, the system 200 includes a local user processor 202 which is in signal communication with a local user computer readable memory device (“user memory”) 210. The user memory 210 can include random access memory components (RAM 212) and read only memory components (ROM 216). The system 200 further includes an imaging device 230 (“Printer 1”), which in turns includes an internal “printer” processor 232 and internal computer readable memory device (“printer memory”) 234 that is in signal communication with the printer processor 232. The printer memory 234 can include random access memory components (RAM 236) and read only memory components (ROM 238). The printer 230 further includes document printing components 254, such as imaging media supply trays, media transport devices to move imaging media through the printer 230, and image forming components to form images on the media. The specific document printing components 254 provided will depend on the general process used for image forming (e.g., ink jet printing or laser printing), however document printing components 254 are well understood in the art, and need not be described further herein.

While FIG. 3 depicts the system 200 as having two processors 202, 232, and two computer readable memory devices 210, 234, a system having only a single processor and/or a single computer readable memory device can be provided to equal effect. Further, functionality described below with respect to a specific processor 202, 232, or a specific computer readable memory device 210, 234, does not necessarily have to be performed by the indicated processor or memory device, but can be performed by the other processor or memory device (respectively). Thus, for example, while a halftoning process is typically performed within a document printing device (e.g., printer 230), this is not a requirement, and the halftoning process can be performed in the user processor 202. Likewise, generation of the authentication key from the digital halftone file can be performed by either user processor 202 or printer processor 232.

The local user processor 202 can be, for example, a personal computer. Accordingly, the user processor 202 can be in signal communication with a user input device such as keyboard 204, and a display device such as monitor 206. The user processor 202 can be placed in signal communication with a network 256, such as the Internet, a LAN, or a WAN, for example, via a modem 208 and a network card 9not shown) resident within the user computer 202.

The system 200 can further include a secondary printer 252 (“Printer 2”). As will be described more fully below, Printer 1 230 can be configured to perform authentication methods in accordance with embodiments of the present invention, while Printer 2 252 can be incapable of performing authentication methods in accordance with embodiments of the present invention. More specifically, Printer 1 230 can include the halftoning algorithm 246 used by both a sender and receiver of an electronic document in the authentication key generation process, as described above with respect to FIGS. 1 and 2.

The further details of FIG. 3 will first be described, followed by a description of how the system 200 can be used to perform methods in accordance with the present invention.

As depicted in FIG. 3, user memory RAM 212 can store the electronic document file 214 that is to be authenticated. Likewise, user memory RAM 212 can also store the authentication key 220. User ROM 216 can include a series of computer executable steps (executable by user processor 202) in the form of an authentication routine 218. For example, authentication routine 218 can be a separate user executable program, or a subroutine of an applications program (such as a word processing program or a spreadsheet program). In one exemplary embodiment, authentication routine 218 is accessible from a word processing program. After a user has created or accessed the document file 214, the user can then select a “file/authentication” menu option from the word processing applications program. The authentication menu option can enable a dialog box (displayed on display 206) to allow a user to select such options as “generate authentication key only” or “print document with authentication key.” The dialog box can also allow a user the options to either display the authentication key using the user display 206, or to print the authentication key using printer 230 or 252, to save the authentication key to memory location 220, or even to e-mail the key to a receiver using the modem 208.

The printer RAM 236 can store the initial digital file (or portions thereof) received from the user processor in memory location 240, and can store the digital halftoned file of the initial digital file in memory location 242. The authentication key can be stored in printer RAM memory location 244.

The printer ROM 238 can include a halftoning routine and algorithm 246 which is configured to cause the printer processor 232 to produce a digital halftone image file from an initial image file. That is, the halftoning routine 246 can cause the printer processor 232 to retrieve a copy of the electronic document file from printer RAM 240, convert the initial digital document file 240 to a digital halftone file, and store the digital halftone file in printer RAM location 242.

The printer ROM 238 can further include an authentication key generation routine 248, which comprises a series of computer executable steps configured to cause the printer processor 232 to perform a predetermined mathematical process on the plurality of discrete digital values that make up the digital halftone file 242 to thereby generate the authentication key, and store a copy of the authentication key in the printer RAM memory location 244. The authentication key generation routine 248 can also contain additional executable steps to provide further options for the generation and transfer of the authentication key, as will be described more fully below.

The printer ROM 238 can further include printing routines 250 which are used to control the document printing components 254 during the imaging of sheet media, as well as to perform other control functions in the printer 230.

It will be appreciated that display 206 and user input device (keyboard) 204 can be in signal communication with the printer processor 232 rather than the user processor 202, and that the authentication routine 218 can be resident within printer ROM 238. Accordingly, the generation of the authentication key can be fully supported by an imaging device (printer 230) without requiring an external processor. For example, when user input device 204 is coupled to printer processor 232, a user can specify that a specific print job sent to the printer 230 is to include generation and printing of an authentication key.

One exemplary use of the system 200 to generate a document authentication key will now be described. However, it will be appreciated that a number of different variations of the use of the system 200 are possible, all within the spirit of the present invention. In the following example it will be assumed that a user wishes to print a document and also generate and print an authentication key for the document. Accordingly, a user accesses an electronic document file 214 via user processor 202 and keyboard 204. The user can then use the authentication routine 218 to indicate that the document represented by the electronic document file 214 is to be printed as a tangible copy, and that an authentication key is to be generated for the document file and also printed with the document, either as a separate page or on the printed document itself. A print job, bearing the electronic document file and the authentication key instructions, is then transmitted to the printer 230. The printer processor 232 stores the electronic document file in printer RAM 240. The printer processor 232 then calls the halftoning routine 246, which renders the initial digital file 240 as a digital halftoned file, which is then stored in printer memory 242. Thereafter, acting on the authentication key instruction included with the print job, the printer processor 232 calls the authentication key generation routine 248. The authentication key generation routine 248 performs the predetermined mathematical process (discussed above) on the discrete digital values which comprise the digital halftone file 242, to thereby generate the authentication key. The printer processor 232 then saves the authentication key in printer memory location 244, and proceeds with printing the halftoned file 242 and the authentication key 244 using printing routines 250. At this point the user can then transmit the document file 214 to a receiver using the modem 208, and can communicate the authentication key to the receiver by any of the means discussed above (telephone, facsimile, e-mail, etc.).

In one variation, rather than printing the authentication key, the printer processor 232 can transmit the authentication key 244 to the user processor 202, and the authentication key can be stored in memory 220. The user can then display the authentication key on the display 206.

As a further example of the use of the system 200, a receiver of an electronic document file can use the system 200 to authenticate the document file. Thus, following from the example just described of how a user (sender) can generate an authentication key for an original document file, the receiver has received both the electronic document file and the authentication key from the sender. The receiver stores the electronic document file in RAM location 214. It is assumed that the receiver has also received the authentication key generated by the sender, and has recorded the sender authentication key (as, for example by writing the authentication key on paper, or saving an e-mail containing the sender authentication key). The receiver then proceeds to generate a receiver authentication key using the electronic document file 214 in essentially the same manner as the sender generated the sender authentication key in the example described above. That is, the electronic document file 214 is rendered as a digital halftone image file by printer processor 232, and a receiver authentication key is generated using the halftone image file. The receiver can then compare the authentication key received from the sender to the authentication key generated by the receiver. If the two keys match, then the receiver's copy of the electronic document file is authenticated. However, if the two keys do not match, then the authenticity of the receiver's copy of the electronic document file is not verified.

As discussed earlier, methods and apparatus described herein generally require that the same halftoning algorithm be used to generate the digital halftone file at the “sender” and “receiver” locations. Likewise, the “sender” and “receiver” generally need to apply the same mathematical process on the digital halftone file to generate the final authentication key. Accordingly, methods and apparatus described herein are particularly useful in an enterprise environment such as a “home office/field office” arrangement. For example, the field office can send the home office a proposed sales contract in the form of an electronic document file via a network connection (e.g., via the Internet), and the home office may wish to authenticate the electronic document file to ensure that it has not been altered during transmission. Since the home office and field office are typically related entities, it is easy to coordinate having printers at each location that include the appropriate halftoning algorithms and authentication key generating routines to allow electronic document authentication, as described herein, to be performed between the two locations. For example, a particular make and model of a printing device can be specified in a corporate setting as the printing device to be used for electronic document authentication processes, thus establishing a common halftoning algorithm to be used. Further, the manufacturer of a selected printing device can be consulted to determine a serial number range of a particular make and model of a printing device to ensure that all such printing devices used for electronic document authentication use the same halftoning algorithm. In certain instances, if a manufacturer has upgraded a particular make and model of a printing device with a new or modified halftoning algorithm, then printers to be used in an enterprise environment for electronic document file authentication can be provided with new firmware (the new or revised halftoning algorithm on a semiconductor, for example) so that all printing devices to be used for authentication purposes have the same halftoning algorithm.

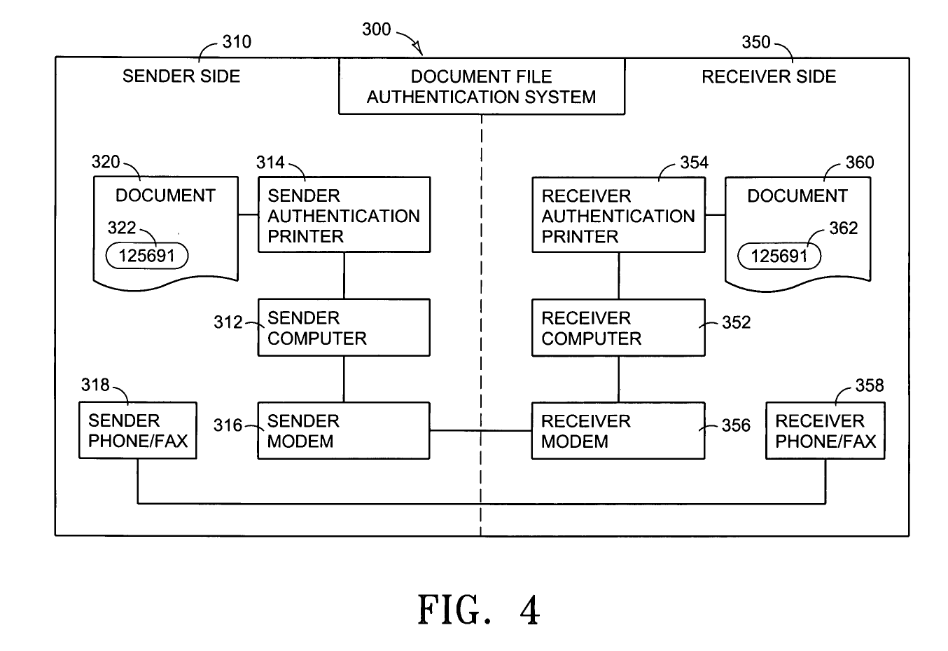

FIG. 4 is a schematic diagram depicting a system 300 in an enterprise environment that can be used to authenticate an electronic document file in accordance with yet another embodiment of the present invention. The system 300 is separated into a “Sender Side” 310 and a “Receiver Side” 350. As indicated from the above description of FIGS. 1-3, the sender (sender side 310) is the source of the electronic document file that is to be authenticated by a receiver (receiver side 350) of the electronic document file. The sender side 310 of the system 300 includes a sender computer 312 (similar to user computer 202, FIG. 3) configured to provide an electronic document file in the form of a sender initial digital file (e.g., document file 214, FIG. 3). The sender side 310 (FIG. 4) further includes a sender printer 314, which can be similar to the printer 230 of FIG. 3. That is, sender printer 314 of FIG. 4 is configured to receive the sender initial digital file, apply a predetermined halftoning process to the sender initial digital file to generate a first digital halftone file comprising a first plurality of discrete digital values, and perform a predetermined mathematical process on the first plurality of discrete digital values to thereby generate a sender authentication key. Apparatus and methods for performing the just-recited functionality of sender printer 314 were described above in detail with respect to printer 230 of FIG. 3, and such apparatus and methods can be incorporated into the sender printer 314 of FIG. 4. In the example depicted in FIG. 4, the sender authentication key generated by the sender printer 314 is displayed on the printed, tangible copy of the document 320 as authentication key 322, here being the number “125691”. However, as described above with respect to FIG. 3, the sender authentication key can also be displayed to the sender via a display device, such as monitor 206 of FIG. 3.

The sender side 310 (FIG. 4) of system 300 can further include a network connection configurable to allow the sender computer 312 to send the sender's version of an initial digital file to a receiver computer 352 (described below). For example, the sender modem 316 can allow the sender computer 312 to connect to the Internet, or to an intranet, which can also be accessed the receiver computer 352 via receiver modem 356. Alternately, the sender computer 312 can be provided with a network interface card (not shown) to allow the sender computer to communicate with a server as part of a LAN or WAN which is also accessible by the receiver computer 352. The sender side 310 of system 300 can also be provided with a sender telephone and/or a sender facsimile machine 318 to allow the sender to communicate the sender authentication key to the receiver via a complimentary receiver telephone/facsimile 358.

The receiver side 350 of the system 300 includes a receiver computer 352 configured to receive the electronic document file from the sender side 310 as a receiver initial digital file. It will be appreciated that the receiver computer 352 can be configured the same as the sender computer 312 and the user computer 202 (of FIG. 3). The receiver side 350 further includes a receiver printer 354 configured to receive the receiver initial digital file, apply the predetermined halftoning process (i.e., the same halftoning process as applied by sender printer 314) to the receiver initial digital file to generate a second digital halftone file comprising a second plurality of discrete digital values. If the electronic document file has not been altered in the process of being transmitted from the sender side 310 to the receiver side 350, then the second digital halftone file, and the second plurality of discrete digital values, produced by the receiver printer 354, should be identical to the first digital halftone file, and the first plurality of discrete digital values, produced by the sender printer 314. The sender printer 354 is further configured to perform the predetermined mathematical process (i.e., the same mathematical process as applied by sender printer 314) on the second plurality of discrete digital values to thereby generate a receiver authentication key. The receiver printer 354 can then display the receiver authentication key to a receiver, as for example by printing the digital halftoned file as the tangible document 360, which includes the authentication key 362. In the example depicted in FIG. 4, it is seen that the sender authentication key 322 and the receiver authentication key 362 are the same (both being the number “125691”), and therefore the electronic document file sent from the sender side 310 to the receiver side 350 is authenticated.

It will be appreciated that the sender side 310 and the receiver side 350 of the system 300 depicted in FIG. 4 are essentially mirror images of one another. Thus, either side 310, 350 can act as “sender” or “receiver” of an electronic document file to be authenticated. It will also be appreciated that the authentication key generated by either the sender side 310 or the receiver side 350 can be stored or displayed in a number of different ways, in accordance with the description provided above with respect to the system 200 of FIG. 3.

While the above invention has been described in language more or less specific as to structural and methodical features, it is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A method of generating an authentication key that can be used to authenticate an electronic document file representative of a document, comprising:
providing the electronic document file as an initial digital file;
applying a predetermined halftoning process to the digital file to generate a digital halftone file comprising a plurality of discrete digital values; and
performing a predetermined mathematical process on the plurality of discrete digital values to thereby generate the authentication key.

2. The method of claim 1, and further comprising printing the digital halftone file to provide a tangible copy of the document containing a visible representation of the authentication key.

3. The method of claim 1, and further comprising displaying the digital halftone file on a user display to provide a visible copy of the document and the authentication key.

4. The method of claim 1, and wherein the halftoning process is based, at least in part, on an error diffusion halftoning algorithm.

5. The method of claim 1, and wherein the halftoning process is based, at least in part, on one of a matrix-based halftoning algorithm, a pattern-based halftoning algorithm, or an ordered-dither halftoning algorithm.

6. The method of claim 1, and wherein the predetermined mathematical process is a summation process.

7. A method of authenticating an electronic document file representative of a document, comprising:
receiving the electronic document file as an initial digital file;
applying a predetermined halftoning process to the digital file to generate a digital halftone file comprising a plurality of discrete digital values;
performing a predetermined mathematical process on the plurality of discrete digital values to generate an authentication key; and
using the authentication key to authenticate the electronic document file.

8. The method of claim 7, and wherein using the authentication key to authenticate the electronic document file comprises:
receiving a sender authentication key; and
comparing the sender authentication key to the generated authentication key and, if the keys are the same, authenticity of the electronic document file is verified.

9. The method of claim 7, and wherein the halftoning process is based, at least in part, on an error diffusion halftoning algorithm.

10. The method of claim 7, and wherein the halftoning process is based, at least in part, on one of a matrix-based halftoning algorithm, a pattern-based halftoning algorithm, or an ordered-dither halftoning algorithm.

11. The method of claim 7, and wherein the predetermined mathematical process is a summation process.

12. The method of claim 9, and wherein the electronic document file is received from a sender via a network.

13. The method of claim 10, and wherein the sender authentication key is received via one of telephone or facsimile.

14. A system to generate an authentication key to be used to authenticate an electronic document file representative of a document, comprising:
a processor; and
a computer readable memory device which is readable by the processor, the computer readable memory device containing a series of computer executable steps configured to cause the processor to:
retrieve a copy of the electronic document file as an initial digital file;
apply a predetermined halftoning process to the initial digital file to generate a digital halftone file comprising a plurality of discrete digital values;
perform a predetermined mathematical process on the plurality of discrete digital values to thereby generate the authentication key; and
store a copy of the authentication key in the computer readable memory device.

15. The system of claim 14, and wherein the processor and the computer readable memory device are resident within a document printing device.

16. The system of claim 15, and wherein the series of computer executable steps are further configured to cause the processor to print a tangible copy of the halftone image file as the document, and to include the authentication key on the tangible copy of the halftone image file.

17. The system of claim 14, and wherein the computer readable memory is configured to store, at least temporarily, a copy of the electronic document file as the initial digital document file.

18. The system of claim 15, and further comprising a user display, and wherein the series of computer executable steps are further configured to cause the processor to display, via the user display, the authentication key.

19. A system for authenticating an electronic document file representative of a document, comprising:
a processor;
a computer readable memory device which is readable by the processor and which is configured to receive the electronic document file as an initial digital file; and
wherein:
the computer readable memory device contains a series of computer executable steps configured to cause the processor to:
store the initial digital file in the computer readable memory device;
apply a predetermined halftoning process to the initial digital file to generate a digital halftone file comprising a plurality of discrete digital values;
perform a predetermined mathematical process on the plurality of discrete digital values to thereby generate the authentication key; and
display a copy of the authentication key to a user via one of a printer or a user display.

20. The system of claim 19, and further comprising a modem configured to receive the initial digital file from a sender and communicate the file, via the processor, to the computer readable memory device.

21. The system of claim 19, and further comprising one of a telephone or a facsimile machine configured to receive a sender authentication key that can be compared to the generated authentication key to authenticate the electronic document file.

22. The system of claim 19, and wherein the processor and the computer readable memory device are resident within a document printing device.

23. An system to authenticate an electronic document file, comprising:
a sender computer configured to provide the electronic document file in the form of a sender initial digital file;
a sender printer configured to:
receive the sender initial digital file;
apply a predetermined halftoning process to the sender initial digital file to generate a first digital halftone file comprising a first plurality of discrete digital values;
perform a predetermined mathematical process on the first plurality of discrete digital values to thereby generate a sender authentication key; and
display the sender authentication key to a sender;
a receiver computer configured to receive the electronic document file from the sender as a receiver initial digital file;
a receiver printer configured to:
receive the receiver initial digital file;
apply the predetermined halftoning process to the receiver initial digital file to generate a second digital halftone file comprising a second plurality of discrete digital values;
perform the predetermined mathematical process on the second plurality of discrete digital values to thereby generate a receiver authentication key; and
display the receiver authentication key to a receiver.

24. The system of claim 23, and further comprising a network connection configurable to allow the sender computer to send the sender initial digital file to the receiver computer.

25. The system of claim 23, and further comprising one of:
a sender telephone and a receiver telephone to allow the sender to communicate the sender authentication key to the receiver; or
a sender facsimile machine and a receiver facsimile machine to allow the sender to communicate the sender authentication key to the receiver.
